(19) United States
(12) Patent Application Publication
(10) Pub. No.: US 2009/0269573 A1
(43) Pub. Date: Oct. 29, 2009

(54) High-Performance Composite Material and Manufacturing Method thereof

(75) Inventors: Mamoru Omori, Sendai-shi (JP); Toshiyuki Hashida, Sendai-shi (JP); Hisamichi Kimura, Sendai-shi (JP); Akira Okubo, Sendai-shi (JP); Yoshihiro Murakami, Sendai-shi (JP); Shun Ito, Sendai-shi (JP); Akihisa Inoue, Sendai-shi (JP)

Correspondence Address: OLIFF & BERRIDGE, PLC, P.O. BOX 320850, ALEXANDRIA, VA, 22320-4850, US

(73) Assignee: National University Corporation Tohoku University, Sendai-shi (JP)

(21) Appl. No.: 11/991,567

(22) PCT Filed: Aug. 31, 2006
(86) PCT No.: PCT/JP2006/317183

§ 371 Date: Apr. 4, 2008

(30) Foreign Application Priority Data
Sep. 7, 2005 (JP) 2005-259281
Mar. 31, 2006 (JP) 2006-098760

(51) Int. Cl. B32B 5/16; C04B 35/52

(52) U.S. Cl. 428/323; 501/100

(57) ABSTRACT

The present invention provides a new high-performance composite material that uses inexpensive materials, has high toughness, has a low coefficient of friction, excellent wear resistance, lower electrical resistance, and excellent electromagnetic wave absorption, and corresponding manufacturing method.

A sintered body containing 0.1˜90 mass % of carbon nanotubes 2 and 99.9˜10 mass % of alumina-silica ceramic 3. The alumina-silica ceramic 3 contains 99.5˜5 mass % alumina and 0.5˜95 mass % silica. A nanocomposite 1, wherein the nano crystals of the carbon nanotubes 2 and the alumina-silica ceramic 3 are mutually intertwined, exists as a construction element. The carbon nanotubes 2 and alumina-silica ceramic 3 raw materials are placed in a water or alcohol solvent to form a slurry that is then stirred for 3˜180 minutes after which the solvent is removed from this mixture material that is then sintered in a non-oxygenated atmosphere in the temperature range of 800° C.˜1,800° C. for 5 minutes to 5 hours.

### BACKGROUND

1. Field of the Invention

The present invention relates to a composite material consisting of an alumina-silica ceramic containing alumina and silica, which are important for a practical ceramic, and carbon nanotubes; and to a high-performance, which improves conventional ceramic performance and further adds new functions; and to the corresponding manufacturing method.

2. Description of the Related Art

Ceramics made from alumina-silica are inexpensive and thus are utilized in a wide range of industrial applications. This ceramics is excellent in oxidation resistance in comparison to metals. Additionally, because they are insulators that prevent the flow of electricity and are dielectric, they absorb electromagnetic waves although only in small amounts. Alumina-silica also has excellent corrosion resistance. However, since compared to metal these ceramics have inferior toughness, insufficient reliability as a material, and break easily under applied stress, their range of application could be greatly increased if their mechanical performance could be improved. Furthermore, applications beyond the range of use of conventional ceramics would be possible if composite materials possessing electrical conductivity like metals or excellent electromagnetic wave absorption performance could be developed.

Carbon nanotubes are a material discovered in 1991 (See Non-Patent Document 1, for example). This material is a nano fiber constructed of fine tubes having a high aspect ratio. The chemical properties are similar to those of graphite materials. It has been reported that carbon nanotubes possess much higher strength and elastic modulus than other materials, and the elastic modulus of composite carbon nanotubes is 1,800 GPa (See Non-Patent Document 2, for example), and the strength of a single-wall of carbon nanotubes is 45 GPa (See Non-Patent Document 3, for example).

Some of the materials being actively developed to utilize these mechanical strength characteristics of carbon nanotubes are composite materials containing carbon nanotubes and materials to solidified these. No major problems occur when these composite materials are synthesized at room temperature or temperatures close to this, or more specifically, when using polymers to synthesize composite materials from carbon nanotubes. When metal or ceramic is used, however, synthesis is performed at high temperature, which induces a difference in thermal expansion between the two materials, which causes the problem of residual stress. Carbon nanotubes undergo almost no expansion even when the temperature is increased (See Non-Patent Document 4, for example). Compared to this, the coefficient of thermal expansion of the metal or ceramic combined with the carbon nanotubes is very large at 4×10⁶˜20×10⁻⁶/K. This creates a large residual stress between the carbon nanotubes and the other materials. Unless a material with a low residual stress is composed, it will not be possible to use these as practical industrial materials. Moreover, compared to particles, it is difficult to evenly distribute the needle-shaped carbon nanotubes in a matrix. In particular, the higher the ratio of carbon nanotubes, the harder to obtain uniform distribution, which has heretofore prevented the manufacture of excellent composite materials.

The synthesis of composite materials made of carbon nanotubes and alumina-silica has been done using separate alumina and separate silica. The main method has been used is to combine the carbon nanotubes with the alumina powder and then sintering this as the raw material. The granule diameter of alumina powder starting material used for this method is 200 nm or larger and normally increases to over 1,000 nm after sintering. The carbon nanotubes are contained inside the alumina crystal grains or are distributed at the grain boundaries. It has been reported that even with this type of distribution, the toughness of alumina single-wall carbon nanotube composite material is 3 times greater than alumina alone when 10 vol % of single-wall nanotubes are added (See Non-Patent Document 5, for example). Subsequent research, however, has shown that this reported improvement in toughness is in error and that the toughness of the alumina single-wall carbon nanotube composite material is about the same as alumina only (See Non-Patent Document 6, for example).

A reported example of the improvement of mechanical properties was when fine alumina powder was combined with 10 vol % multi-wall carbon nanotubes to obtain a composite material toughness value 24% greater than alumina alone (See Non-Patent Document 7, for example). Material development using alumina powder in the same way has also been conducted to reduce the alumina electrical resistance value (See Patent Document 1, for example). Adding 0.1 vol % of carbon nanotubes reduced the electrical resistance from an order of 10¹³ to 10⁶. There are also methods that use the alumina precursor instead of alumina powder as the raw material that is combined with the carbon nanotubes and sintered. This method uses butoxy aluminum (Al(OC₄H₉)₃) in the alumina precursor, dissolves this in alcohol, adds and combines multi-wall carbon nanotubes, adds water, hydrolyzes the butoxy aluminum, and dries the mixture before preheating it to 1,250° C. in a non-oxygenated atmosphere and combining carbon nanotubes and alumina to form a powder that is then sintered. The granule diameter of the alumina powder mixture obtained here has grown to 500 nm or more, and the grain diameter of the alumina in the compound material obtained from sintering increases in size to 1,000 nm or more, and the carbon nanotubes are distributed within the alumina grains while at the same time forming nodules having grain boundaries. The toughness of this composite material maximizes when 1.5 vol % of carbon nanotubes is added and is only 1.1 times large than when alumina is used alone (See Non-Patent Document 8, for example). In such methods described above, since the granule diameter of the powder used as the starting material is large, it is impossible to make the size of the alumina crystals in the composite material 500 mm or smaller.

There have been reports of manufacturing nanocomposite materials of alumina and carbon nanotubes (See Patent Document 10, for example). Here too, alumina powder is being used as the raw material. As the use of this method requires control under strict manufacturing conditions to manufacture the nanocomposite material without growing the alumina crystals, and increasing the manufacturing cost cannot be avoided. In regards to using another substance other than alumina powder as the raw material, there are some citations where aluminum hydroxide is used (See Patent Document 3, for example). However, it is difficult to manufacture high-performance composite materials because when composite materials are manufactured from pure aluminum hydroxide, the alumina crystals grow to 20 mm in size or larger, separation occurs between the carbon nanotubes and the alumina matrix, and the carbon nanotubes exist as nodules. Composite materials of just silica and carbon nanotubes are also being manufactured (See Non-Patent Document 9, for example). This is done by using ultrasonic equipment to mix carbon nanotubes, water, and tetraethoxysilane into a gel, which is then poured into a sodium hydroxide solution, dried, and then subjected to a laser beam to fuse the silica and synthesize the composite material. Composite materials of just silica are soft and brittle and show little promise of greatly improved mechanical performance as a composite material.

The coefficient of thermal expansion of alumina is 8×10⁻⁶/K, the coefficient of thermal expansion of mullite (3Al₂O₃.2SiO₂) is 4×10⁻⁶/K, and the coefficient of thermal expansion of silica is 0.5×10⁻⁶/K. The coefficient of thermal expansion for other than silica is larger than that for carbon nanotubes, so if carbon nanotubes exist in alumina-silica ceramic crystals, the alumina-silica ceramic contracts while cooling from the sinter temperature to room temperature while the carbon nanotubes do not contract, which generates a large residual stress and makes it difficult to produce composite materials with a high degree of toughness and strength. In addition, the carbon nanotubes that exist at the grain boundaries of the alumina-silica ceramic have only a small effect in preventing the growth of propagating cracks, so as shown by the above-mentioned report the toughness and strength of carbon nanotube-alumina composite materials are not high. Further, if the ceramic powder and carbon nanotubes are mixed in slurry form during composite material manufacture, the carbon nanotubes will condense and ceramic powder material will not enter the structure of the condensed carbon nanotubes, which will cause the carbon nanotubes to form caogulated lumps inside the synthesized composite material.

Non-Patent Document 1: S. Iijima, “Helical Microtubules of Graphite Carbon,” Nature, (UK), 1991, 354, 56-58.

Non-Patent Document 2: M. M. J. Treacy and T. W. Ebbesen, “Exeptionally High Young's Modulus Observed for Individual Carbon Nanotubes,” Nature, (UK), 1996, 381, 678-680.

Non-Patent Document 3: D. A. Walters, L. M. Ericson, M. J. Casavant, J. Liu, D. T. Colbert, K. A. Smithand, R. E. Smalley, “Elastic Strain of Freely Suspended Single-Wall Carbon Nanotube Ropes,” Applied Physics Letter, (USA), 1999, 74 [25], 3803-3805.

Non-Patent Document 4: Y. Maniwa, R. Fujiwara, H. Kira, H. Tou, H. Kataura, S. Suzuki, Y Achiba, E. Nishibori, M. Takata, M. Sakata, A. Fujiwara, and H. Suematsu, “Thermal Expansion of Single-Walled Carbon Nanotube (SWNT) Bundles: X-ray Diffraction Studies,” Physical Review B, (USA), 2001, 64, 241402-1-3.

Non-Patent Document 5: G-D. Zhan, J. D. Kuntz, J. Wan, and A. K. Mukherjee, “Single-Wall Carbon Nanotubes as Attractive Toughening Agents in Alumina-Based Nanocomposites,” Nature Material, (UK), 2003, 2, 38-42.

Non-Patent Document 6: X. Wang, N. P. Padture, and H. Tanaka, “Contact-Damage-Resistance Ceramic/Single-Wall Carbon Nanotubes and Ceramic/Graphite Composites,” Nature Material, (UK), 2004, 3, 539-544.

Non-Patent Document 7: R. W. Siegel, S. K. Chang, B. J. Ash, J. Stone, P. M. Ajayan, R. W. Doremus, and L. S. Schadler, “Mechanical Behavior of Polymer and Ceramics Matrix Nanocomposites,” Scripta Material, (USA), 2001, 44, 2061-2064.

Patent Document 1: Japanese Patent Application Laid-open No. 2004-244273

Non-Patent Application 8: C. B. Mo, S. I. Cha, K. T. Kim, K. H. Lee, and S. H. Hong), “Fabrication of Carbon Nanotube Reinforced Alumina Matrix Nanocomposite by Sol-Gel Process,” Material Science and Engineering, (USA), 2005, A 395, 124-128.

Patent Document 2: Japanese Patent Publication No. 2004-507434

Patent Document 3: Japanese Patent Application Laid-open No. 2004-256382

Non-Patent Document 9: T. Seeger, G dela Fuente, W. K. Maser, A. M. Benito, M. A. Callejas, and M. T. Martinez, “Evolution of Multiwalled Carbon-Nanotube/SiO₂ Composites via Laser Treatment,” Nanotechnology, (UK), 2003, 14, 184-197.

### SUMMARY

The prior arts as described above have the problem that it is not possible to manufacture alumina-silica ceramic composite materials with excellent mechanical and electrical properties by adding a quantity of carbon nanotubes.

The present invention focused on this problem, and the objective of the present invention is to provide a new high-performance composite material that uses inexpensive materials, has high toughness, has a low coefficient of friction, excellent wear resistance, lower electrical resistance, and excellent electromagnetic wave absorption, and corresponding manufacturing method.

In order to achieve the above objective, a high-performance composite material of the present invention is comprised of sintered bodies containing 0.1˜90 mass % carbon nanotubes and 99.9˜10 mass % alumina-silica ceramic, wherein the alumina-silica ceramic contains 99.5˜5 mass % alumina and 0.5˜95 mass % silica; and having included nanocomposite structural elements of the carbon nanotubes and the alumina-silica ceramic nano crystals being mutually intertwined.

The high-performance composite material manufacturing method of the present invention comprises the steps of placing the carbon nanotubes and the alumina-silica ceramic raw material containing 99.5˜5 mass % of aluminum hydroxide (Al(OH)₃) in a suitable quantity of alumina and 0.5˜95 mass % silica gel (SiO₂.nH₂O) in a suitable quantity of silica in a water or alcohol solvent at a ratio of 0.1˜90 mass % of the carbon nanotubes and 99.9˜10 mass % of the alumina-silica ceramic material, creating a slurry that is mixed for 3˜180 minutes, and then removing the solvent from the raw material mixture, and sintering for 5 minutes to 5 hours in a temperature range of 800° C.˜1,800° C. in a non-oxygenated atmosphere.

The inventors of the present invention carefully researched the affect on alumina-silica ceramic crystal growth of carbon nanotubes and their dispersibility. As a result it was discovered that the carbon nanotubes suppressed the growth of the alumina-silica ceramic crystal nucleuses into large crystals and that their dispersibility could also be improved. More specifically, the precursor that generates the alumina-silica ceramic crystals for the starting material, in other words, using aluminum hydroxide and silica gel improves the dispersibility in the carbon nanotube composite material and suppresses the ceramic crystal growth to a nano size under 200 nm. For that reason, an intertwined nanocomposites where the carbon nanotubes as mediator combine the multiple alumina-silica ceramic nano crystals is formed. When the ceramic nano crystals in this nanocomposites contract, the carbon nanotubes intertwined with them are able to deform which reduces significant residual stress within the composite material and improves the toughness and strength of the entire composite material.

Composite materials obtained by alumina alone, however, undergo large ceramic crystal growth of 20 mm or greater, which remarkably reduces the strength of the composite material. Compared to this, the ceramic phase of the alumina-silica ceramic composite material is not single phase, so the affect of the mixed in mullite phase suppresses the alumina crystal growth to keep the size under 20 mm and only several mm at the largest. This was shown to increase dispersibility and improve the mechanical properties, electrical conductivity, and electromagnetic wave absorption by adding only a small quantity of carbon nanotubes. Thus, the inventors completed the present invention for a high-performance composite material and the corresponding manufacturing method.

In the high-performance composite materials of the present invention, the nanocomposites, in which the carbon nanotubes and alumina-silica ceramic nano crystals are mutually intertwined, is a composite material with high toughness and strength, and this is dispersed within the alumina-silica ceramic. This provides high toughness. This allows the characteristics of the carbon nanotube graphite to be utilized, improves the wear resistance characteristics, and gives a low coefficient of friction. This changes the material from an insulator to a conductor and provides low electrical resistance and excellent electromagnetic wave absorption. In addition, inexpensive alumina-silica ceramic material can be used for the raw material. It is preferable for the high-performance composite material of the present invention to have a coefficient of friction of 0.07˜0.30 and electrical resistance of 10⁻²˜10⁷ Ω/cm. The manufacturing method of the high-performance composite material of the present invention can manufacture the high-performance composite material of the present invention.

In the high-performance composite material and corresponding manufacturing method of the present invention, carbon nanotubes is the collective designation for single-wall carbon nanotubes, double-wall carbon nanotubes, multi-wall carbon nanotubes, non-crystalline carbon nanotubes, and carbon nanorods, etc. Any of which may be used either individually or in a combination of two or more. The performance improvement effect does not change in any of these cases.

In the high-performance composite material manufacturing method of the present invention, it is preferable that a rotating super mixer that can automatically and evenly mix the slurry without destroying the carbon nanotubes to be used. For the sintering, basically, pressureless sintering is possible, but densification is easier when pressured sintering is used at the greater quantity of carbon nanotubes that is used per the quantity of alumina-silica ceramic. It is preferable to use a hot press (HP) or a spark plasma sintering (SPS) for the pressurized sintering equipment.

In the high-performance composite material manufacturing method of the present invention, it is preferable that the preprocessing for the sintering be to first remove the solvent from the mixed material and then performing pre-sintering in a non-oxygenated atmosphere in a temperature range of 200° C.˜900° C. for 5˜60 minutes to decompose and remove the water. This makes it possible to quickly raise the temperature at sintering to suppress the contraction rate during sintering and prevent cracking of the product. This also prevents the sintering furnace from corrosion with moisture.

The present invention provides a new high-performance composite material that uses inexpensive materials, has high toughness, has a low coefficient of friction, excellent wear resistance, lower electrical resistance, and excellent electromagnetic wave absorption, and the corresponding manufacturing method. This enables to provide a high-performance composite material that can be used in fields where conventional alumina-silica ceramics cannot be used, and the corresponding manufacturing method.

### BRIEF DESCRIPTION OF THE DRAWINGS

FIG. 1 is a view showing an alumina-silica nanocomposite of the high-performance composite material of an embodiment of the present invention.

### DETAILED DESCRIPTION

The best mode for carrying out the invention is described in detail hereafter. The high-performance composite material of an embodiment of the present invention is manufactured using a high-performance composite material manufacturing method of an embodiment of the present invention.

The industrial-use alumina is manufactured using the Bayer process. More specifically, the raw material bauxite is combined with a sodium hydroxide solution and heat treated to make sodium aluminate solution, which is then diluted before adding aluminum hydroxide seed crystals, and separated out the aluminum hydroxide. This aluminum hydroxide is then baked at over 1,200° C. to manufacture alumina powder. Therefore, the aluminum hydroxide is the alumina precursor and is less expensive than alumina. The aluminum hydroxide begins to degrade at 276° C. and this degradation is completed at 375° C. to form alumina crystal nucleuses. This nucleus crystal growth becomes prominent at over 1,000° C.

Silica gel is produced by adding hydrochloric acid or another acid to a sodium silicate (liquid glass) aqueous solution, neutralizing this solution, allowing it to precipitate, and then washing and drying the precipitate. Sodium silicate is an inexpensive material and silica gel can also be obtained inexpensively as an industrial material. The silica gel begins losing water at the low temperature of approximately 30° C. with decomposition maximizing at 81° C. to form amorphous silica.

The alumina-silica ceramic of the high-performance composite material and the corresponding manufacturing method of an embodiment of the current invention does not contain singular alumina. Synthesizing a composite material from aluminum hydroxide alone and carbon nanotubes causes the alumina to form grains larger than 20 mm during sintering. This grain growth process causes the carbon nanotubes to group together and this aggregation results in poor dispersibility, which markedly reduces the mechanical and electrical properties of the obtained composite material. The silica synthesized within the composite material is amorphous and not crystalline, so degradation in performance due to grain growth is not a problem. However, since silica is a soft and brittle ceramic, it must be strengthened with alumina to produce a composite material that can be used as a material.

The carbon nanotubes used in the high-performance composite material and corresponding manufacturing method in an embodiment of the present invention are mainly produced using the arc discharge method, laser vaporization method, plasma synthesis method, or hydrocarbon catalyst decomposition method. The carbon nanotubes manufactured using these methods also include single-wall carbon nanotubes, double-wall carbon nanotubes, multi-wall carbon nanotubes, amorphose carbon nanotubes, and carbon nanotubes called carbon nanorods because the hollow in them is small or nearly non-existant. Synthesis becomes easy when a metal, such as Fe, Co, Ni, or Ce, is used as the catalyst, so these metals exist in many carbon nanotube products. However, since this metal catalysts can be removed by acid washing, there are no usage problems. In addition to these metal impurities, often carbon impurities, such as amorphous carbon or fullerene, are contained. However, even if these impurities are mixed in, if their ratio is less than 50% by weight, even if these are used as a material, there is not marked decrease in composite material performance compared to when pure nanotubes are used. However, the higher the ratio of nanotubes, the more advantageous it is for synthesizing nanocomposites. There are no major differences in the mechanical properties of these 5 types of carbon nanotubes, so there is no difference in the effect whether they are used individually or in combination.

The high-performance composite material manufacturing method of an embodiment of the present invention uses aluminum hydroxide as the alumina precursor. This method also uses silica gel as the silica precursor. The aluminum hydroxide is decomposed at under 400° C. to form alumina nuclei which grow into crystals when heated at a high temperature, and when processed at over 1,200° C. commercial alumina powder is produced. However, when carbon nanotubes, silica, and alumina coexist, the growth of the alumina crystal nuclei and mullite crystal nuclei is suppressed and these crystals do not grow to more than 200 nm even when heated above sintering temperature of the composite material, so growth is stopped in the nano crystal state. Since carbon nanotubes are more than 1,000 nm in length, an intertwined structure are formed with the multiple nano alumina crystals and nano mullite crystals being bridged. Such nano alumina-silica ceramic and carbon nanotube structures are nanocomposites, and to date these have not been reported and were first discovered by the inventors. If the ratio of carbon nanotubes to the alumina-silica ceramic is low, these nanocomposites for a structure where the carbon nanotubes are dispersed as islands in the alumina-silica ceramic polycrystalline matrix. This matrix is alumina-silica ceramic and is a mixed composition of alumina and silica. For this reason, grain growth where the crystals grow larger than 20 mm in the manufactured composite material does not occur as it does with singular alumina.

The strength and toughness of composite materials depend on the degree of the residual stress. Generally, the greater the residual stress, the lower the strength and toughness. The reason for this is that the residual stress can be relaxed by the occurrence of cracks. When general ceramic polycrystalline bodies have relatively little residual stress, the grain boundary strength is generally weak and improved toughness from the crack deflection can be expected, which brings possibilities to improve the strength and toughness. There is a large difference in the thermal expansion of carbon nanotubes and alumina-silica ceramics, so when the carbon nanotubes are evenly dispersed, a large compression stress from the matrix alumina-silica ceramic acts on the carbon nanotubes and generates a large residual stress in the composite material even when the amount of carbon nanotubes added is small. As a result, the larger the amount of carbon nanotubes that is added, the easier it is for cracks to form in the composite material, so using a large amount of carbon nanotubes makes manufacture impossible due to the cracks. Even in an alumina-silica ceramic, for just silica when absolute no alumina is contained, little residual stress is generated by the difference in thermal expansion.

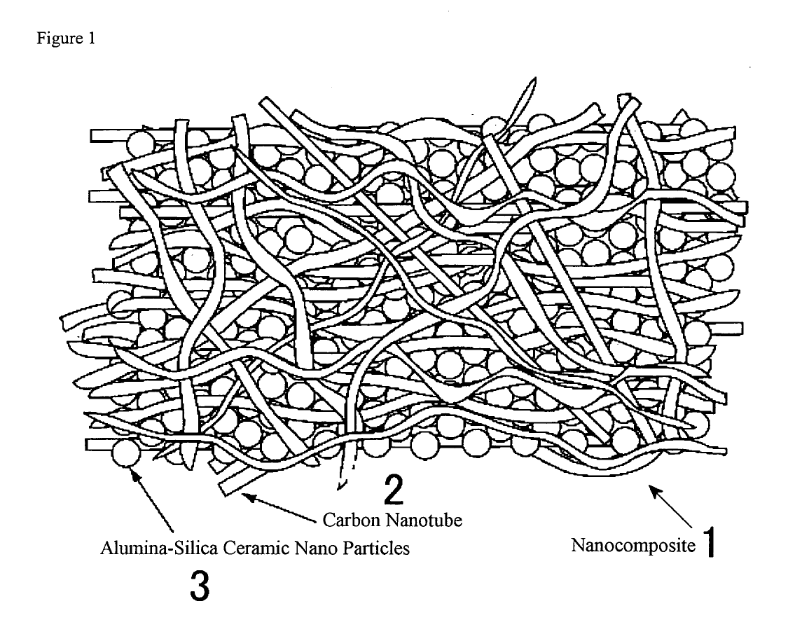

However, the high-performance composite material of an embodiment of the present invention has a structure where even if the ratio of carbon nanotubes is small, the nanocomposites are dispersed in the alumina-silica ceramic and this dispersion is not uniform. As shown in FIG. 1, the nanocomposites 1 contains carbon nanotubes 2 and alumina-silica ceramics 3 captured inside of polycrystals where these to substances are intertwined. The nano alumina-silica ceramics 3 particles are less than 200 nm in size and are intertwined with the carbon nanotubes, which are much longer than the diameters of the particles. There is no possibility of a strong chemical bond forming between these two intertwined substances, so the only binding is due to Van der Waals' forces. If the bonding force is strong in the nanocomposites 1 between the carbon nanotubes 2 and the alumina-silica ceramic 3, it will not be possible to relax the residual stress created by the difference in the thermal expansion between these two substances, so as the quantity of multi-wall carbon nanotubes 2 is increased, the residual stress will eventually lead to the destruction of the composite material. However, the ability to obtain dense composite materials that do not crack shows that the residual stress is being relaxed. More specifically, the bonding by Van der Waals' forces within the nanocomposites 1 allows the multi-walled carbon nanotubes 2 to deform. The carbon nanotubes 2 can be bent along the length as the nano crystals of the alumina-silica ceramic 3 contract to relax the residual stress. The relaxation of the residual stress does not reduce the toughness or strength of the composite material. As cracks progress within the composite material, pull out of the carbon nanotubes 2 occurs in the nanocomposites 1 and provides much greater toughness and strength. As the ratio of the carbon nanotubes 2 increases, the ratio of the formed nanocomposites 1 also increases and improves residual stress relaxation, so there is absolute no decline in the strength of the composite material.

To manufacture the high-performance composite material of an embodiment of the present invention, slender carbon nanotubes with high anisotropy, aluminum hydroxide, the raw material for alumina-silica ceramics, and silica gel must be evenly mixed together. Since these three raw materials cannot be dissolved in solvent, the mixing technology requires that a method for mixing the powders together be used. There are various powder mixing methods, but since carbon nanotubes have the tendency to aggregate, evenly mixing them in a dry state is difficult. In addition, adding a solvent for wet mixing requires a large quantity of solvent and separation occurs due to the different precipitation speeds caused by the differences in specific gravity, so achieving uniform mixing is difficult. The general method to prevent this separation precipitation is to add the powder to water or alcohol to create a very viscous slurry which is then rotary mixed for along time in a ball mill.

Using the method, however, results in the nanotubes being destroyed by the ball. In the manufacturing method of the high-performance composite material in an embodiment of the present invention, the slurry mixing was automatically done using a revolving super mixer to prevent carbon nanotube destruction and achieve a uniform mixture in a short period of time. This device automatically turns a container containing slurry while rotating the body supporting it in the opposite direction to mix the slurry even though it is of high viscosity. Rotating and turning in the opposite direction in this manner utilizes the shear stress of the slurry to break apart the aggregated portions. This method makes possible uniform mixing in a relatively short time. A surface-activating agent or dispersant is added when the slurry is made to promote dispersion and achieve a uniform mixture in a short period of time.

The sintering of the high-performance composite material of an embodiment of the present invention can basically be performed in a pressureless environment. However, if the mixture ratio of alumina-silica ceramic is lower than the carbon nanotube quantity, then the sintering function of the ceramic will decrease, so it is difficult to create a dense, high-strength sintered material using the pressureless sintering method. Using a pressurized sintering method makes it possible to easily create dense composite materials in all mixture ranges. Pressurized sintering methods with a high commercial usage value are the hot press method (HP) and the spark plasma sintering method (SPS).

The hot press method pressurizes a graphite mold containing the test material while normally using an external heating process in a non-oxygenated atmosphere to raise the temperature to the sintering temperature and then maintains that temperature for a set time to manufacture the product. This method is expected to be effective in promoting densification through pressurization, so it also allows high-performance composite materials with poor sintering performance due to the alumina-silica ceramic being 60 mass % or lower to easily achieve densification.

Spark plasma sintering equipment (SPS) is called, among other things, plasma activation sintering equipment (PAS), spark plasma system (SPS), and pulse current sintering equipment, and these equipment types were developed for the sintering of metals and ceramics and there configuration characteristics are packing test material into a conductive mold and directly applying a pulse direct current to heat the material. This causes a pulse electrical field to act on the test material in the mold to promote diffusion of the material and facilitate easy plastic deformation. In addition, for powder with a high electrical resistance, a minute amount of current is made to flow on the surface of the test material to accelerate the motion of the molecules on the surface of the crystals to promote crystal growth. The movement of molecules is promoted even in a solid-phase reaction, which makes possible reaction at lower temperatures than conventionally. Using this type of SPS effect makes it possible to manufacture sintered bodies from WC only or sintered bodies from AIN or SiC only, which conventionally was not possible.

The high-performance composite material of an embodiment of the present invention is formed of nanocomposites as the composition elements which are formed from sintered bodies containing 0.1˜90 mass % carbon nanotubes and 99.9˜10 mass % alumina-silica ceramics that form these nanocomposites of mutually intertwined carbon nanotubes and alumina-silica ceramic nano crystals. The individual nanocomposites are a composite material with high toughness and strength and dispersing these in the alumina-silica ceramic forms a high-performance composite material with high toughness and strength. When the carbon nanotube mixture fraction is less than 0.1 mass %, the coefficient of friction, which is part of wear resistance performance, cannot be less than the coefficient of friction of alumina. In addition, if the carbon nanotube ratio greater than 90 mass %, the strength of the high-performance composite material will be no different than that of just solidified carbon nanotubes.

Further, the alumina-silica ceramic of the high-performance composite material of an embodiment of the present invention contains 99.5˜5 mass % of alumina and 0.5˜95 mass % of silica. Combining the singular aluminum hydroxide raw material with carbon nanotubes, and then sintering will grow the crystals of the obtained composite material alumina to a particle diameter of more than 20 mm, which remarkably decreases the toughness and strength of and render the material unusable. This crystal growth can be prevented using a mixed composition of alumina and silica, and when the silica mixture quantity is 0.5 mass % or greater, the crystal growth is completely suppressed; making it possible to synthesize a high-performance composite material with high toughness and strength. On the other hand, if the silica mixed quantity is 95 mass % or more, the alumina-silica ceramic becomes soft and brittle and thus reduces the strength of the high-performance composite material; making it difficult to use as a practical material.

Next, a manufacturing method of the high-performance composite material of an embodiment of the present invention is explained. Single-wall carbon nanotubes, double-wall carbon nanotubes, multi-wall carbon nanotubes, amorphous carbon nanotubes, and carbon nanorods can all be used to manufacture high-performance composite materials. In addition, two or more types of these can be used as a composite. Also, aluminum hydroxide, which is an alumina precursor, and silica gel, which is a silica precursor, can be used as the raw material for alumina-silica ceramics.

Next is the mixing of an alumina-silica ceramic and the carbon nanotubes, but first the defined amount of carbon nanotubes must be weighed, place in a container, and water or distilled water, or an alcohol like methanol or ethanol added to create a slurry. To promote good dispersion of the carbon nanotubes in the slurry, a face-activating agent or dispersant can be added to the slurry to shorten the mixing time. These additives also act to adjust the viscosity of the slurry. There are a great many types of fact-activating agents and dispersants, but the ones used here must not contain any elements belong to the alkali or alkali earths groups. This is because if any containing these elements are used, these elements will remain in the composite material. A guideline for the quantity of additive is 0.1˜10 vol % in relation to the solvent. At 0.1 vol % or less the additive effect is small, and at 10 vol % or over the effect stops changing.

Aluminum hydroxide and silica gel power are added to this slurry and mixed for 3˜180 minutes. Uniform mixing can be done effectively by using a rotating and revolving super mixer to perform this mixing. Uniform mixing is not performed at a mixing time of under 3 minutes and no change of state is realized by mixing for more than 180 minutes. The water of the solvent is removed from the mixed slurry and then a hot plate or drier is used to dry that slurry at 150˜250° C. while at the same time degrading the added face-activating agent or dispersant to form a mixture material for sintering.

Using this mixture material as is to obtain an alumina-silica ceramic composite material for sintering is possible. However, when manufacturing products of large shape or raising the temperature quickly, performing pre-sintering decomposition of the mixture material aluminum hydroxide and silica gel and removing the water will suppress the rate of contraction during sintering and preventing cracking of the product, as well as preventing fouling of the atmosphere furnace used for sintering with water. This pre-sintering must be performed in a non-oxygenated atmosphere. In an oxygenated atmosphere the carbon nanotubes will oxidize and disappear. The suitable pre-sintering temperature is a range of 200° C.˜900° C. If the temperature is less than 200° C., decomposition of the aluminum hydroxide or silica gel will not be sufficient, and at more than 900° C. the alumina crystals and mullite crystals will grow large and prevent the formation of carbon nanotube nanocomposites. Also, the suitable pre-sintering time is 5 minutes to 60 minutes. More specifically, if the time is shorter than 5 minutes, sufficient decomposition will not occur, and at a time longer than 60 minutes decomposition will already be completed, so there is not additional effect.

To manufacture the alumina-silica ceramic composite material using the pressureless sintering method, the required shape must be formed before sintering. This forming can be done using injection molding, extrusion molding, slip casting, or another conventional method. The pressureless sintering temperature range is 900° C.˜1,800° C. At less than 900° C. under no pressure, the progress of the sintering is insufficient, and even raising the sintering temperature over 1,800° C., sintering has been completed, so there is no further change in effect from sintering. The pressureless sintering time in a range of 0.2 hours to 5 hours is suitable. At a time shorter than 0.2 hours the sintering is insufficient, and at a time longer than 5 hours there is almost no densification. This pressureless sintering can also be performed using electromagnetic sintering equipment. Graphite material is mixed with polymers and concrete for use as conductive electromagnetic wave absorption agents. In the same way, alumina-silica ceramics are also conductive electromagnetic wave absorption agents. After forming the mixture material for pressureless sintering, electromagnetic sintering equipment is used to heat the mixture material through electromagnetic wave absorption to a temperature of 900° C.˜1,800° C. and maintaining the final attained temperature for 0.1˜3 hours to complete the sintering to obtain the high-performance composite material of an embodiment of the present invention. If the sintering temperature is below 900° C. a dense sintered body cannot be obtained, and since sintering is completed at a temperature of 1,800° C., a temperature higher than that is not required. In regards to the sintering time, sintering is insufficient at a time of less than 0.1 hour, and there is no difference in effect for sintering times longer than 3 hours.

It is advantageous to use the pressurized sintering method for mixture materials with a high carbon nanotube ratio. A hot press and SPS can be used for the pressurized sintering equipment to obtain a dense sintered body. With a hot plate, the mixture material that has been packed into a mold is externally heated to raise the temperature and sintering is performed under pressure. With SPS, pulse direct current is applied to the mold containing the mixture material to directly heat the material and sintering is performed under pressure. The sintering temperature range is 800° C.˜1,600° C., the sintering time is 5 minutes to 2 hours, and the applied pressure is 2˜200 MPa. The sintering temperature is related to the applied pressure, so the applied pressure must be raised in order to lower the sintering temperature. The applied pressure is limited by the pressure resistance performance of the mold. Dense graphite molds can be used in temperatures of up to 2,400° C. and a maximum pressure of 200 MPa. If the sintering temperature is lowered below 800° C., even if the applied pressure is raised to 200 MPa, it will not be possible to densely sinter the composite material, so using a sintering temperature over 800° C. is crucial. Even if the temperature is raised above 1,600° C., sintering is performed at a temperature lower than that, so there is no additional densification effect. A completion time of 5 minutes to 2 hours is suitable. Sintering is insufficient at a time shorter than 5 minutes, and a sintering time of more than 2 hours provides no additional densification effect because sintering is already complete. Increasing the applied pressure above 200 MPa will destroy even graphite molds with excellent pressure resistance, so composite material sintering must be performed at an applied pressure below this, and if the applied pressure is less than 2 MPa, the applied pressure sintering effect will disappear.

If pre-sintering and sintering are performed in an oxygenated atmosphere, the carbon nanotubes will oxidize, so pre-sintering and sintering must be performed in a non-oxygenated vacuum or in a non-oxygenated gas atmosphere, such as one of argon gas, nitrogen gas, or helium gas.

### First Embodiment

Multi-wall carbon nanotube (MWNT), aluminum hydroxide (Al(OH)₃), and silica gel (SiO₂.nH₂O) were measured to obtain the Al₂O₃ and SiO₂ weight ratios shown in Table 1. These materials were mixed with water to form a slurry and to this was added to triethanolamine to attain approximately 3 vol % of water as a dispersant, and then a rotating and revolving super mixer was used to mix for 1 hour. After drying this mixture material, it was heated to 200° C. in the air to decompose the dispersant, and then an atmosphere furnace filled with nitrogen gas was used to raise the temperature to 600° C. in 1.5 hours and then this temperature was maintained for 30 minutes to decompose the aluminum hydroxide and silica gel in the material. This decomposed material was formed in a mold and a graphite heat generating electric furnace with a nitrogen atmosphere was used to raise the temperature to 1,700° C. over 2 hours and then this temperature was maintained for 3 hours to complete the sintering.

Table 1 shows the change in bulk density, flexural strength, toughness, coefficient of friction, and electrical resistance for the MWNT mixture ratio of the obtained composite material. For comparison, Table 1 shows an alumina-silica ceramic sintered body containing no MWNT additives, and an alumina sintered body formed using the aluminum hydroxide raw material that were both synthesized in the same manner. As shown in Table 1, the toughness and flexural strength of the alumina-silica ceramic sintered body containing carbon nanotubes has a very large coefficient of friction and electrical resistance at a certain size. The alumina sintered body has a very small flexural strength for the large grain size of the alumina crystal. Adding a minute amount of MWNT markedly reduces the coefficient of friction and the electrical resistance, which shows the effect of dispersion of the slender carbon nanotubes in the alumina-silica ceramic. Regarding toughness and strength improvement, the effect was not very large when less than 1 Wt % MWNT was added, but when several % were added a large effect was obtained. As the added quantity of MWNT increases, the coefficient of friction and electrical resistance decline greatly. A microwave oven was used to study the electromagnetic wave absorption of obtained composite material. The x symbol shows that no heating occurred even when subjected to electromagnetic waves using a microwave oven. The ∘ symbol shows little heating, and two ∘ shows marked heating. As shown in Table 1, a composite material to which 3 wt % of carbon nanotubes was added, absorbed the electromagnetic waves and heated a little, and adding further carbon nanotubes caused significant heating.

TABLE 1
Alumina-Silica Ceramic Composite Material Obtained Using Pressureless Sintering

| | | | | Flexural | | | Electrical | Microwave |
|---|---|---|---|---|---|---|---|---|
| MWNT | Al₂O₃ | SiO₂ | Density | Strength | Toughness | Coefficient | Resistance | Oven |
| (wt %) | (wt %) | (wt %) | (g/cm³) | (MPa) | (MPa · m^{1/2}) | of Friction | (Ω · cm) | Heating |
| 0.5 | 96.5 | 3.0 | 3.78 | 451 | 3.5 | 0.41 | 1.5 × 0⁸ | X |
| 1 | 96.0 | 3.0 | 3.64 | 556 | 4.1 | 0.34 | 1.5 × 10⁷ | X |
| 3 | 94.5 | 2.5 | 3.53 | 602 | 5.8 | 0.28 | 3.9 × 10⁶ | ◯ |
| 6 | 91.5 | 2.5 | 3.36 | 671 | 6.7 | 0.21 | 1.1 × 10⁴ | ◯◯ |
| 10 | 88.5 | 1.5 | 3.07 | 653 | 6.3 | 0.19 | 5.1 × 10² | ◯◯ |
| 14 | 84.5 | 1.5 | 2.84 | 615 | 6.1 | 0.17 | 4.5 × 10² | ◯◯ |
| 20 | 79.0 | 1.0 | 2.71 | 591 | 5.8 | 0.17 | 1.0 × 10 | ◯◯ |
| 30 | 69.0 | 1.0 | 2.56 | 578 | 5.6 | 0.15 | 8.1 | ◯◯ |
| 40 | 59.6 | 0.4 | 2.31 | 546 | 5.2 | 0.14 | 7.2 | ◯◯ |
| 0 | 99.0 | 1.0 | 3.92 | 420 | 3.2 | 0.78 | 2.1 × 10¹³ | X |
| 0 | 100 | 0 | 3.94 | 190 | 3.3 | 0.80 | 1.2 × 10¹³ | X |

### Second Embodiment

Single-wall carbon nanotubes (SWNT) and multi-wall carbon nanotubes (MWNT) were used and then one of these was measured along with aluminum hydroxide and silica gel to produce a substantial amount of Al₂O₃ and SiO₂ as shown in Table 2 and Table 3. These materials were mixed with water to form a slurry and to this was added gum arabic starch to attain approximately 4 vol % of water as a dispersant, and then a rotating and revolving super mixer was used to mix for 1.5 hours. After drying this mixture material, it was heated to 220° C. in the air to decompose the dispersant, and then an atmosphere furnace filled with nitrogen gas was used to raise the temperature to 200° C. over 0.5 hours, then the temperature was further raised to 400° C. in 1.5 hours and then this temperature was maintained for 30 minutes to decompose the aluminum hydroxide and silica gel in the material. This decomposed and dehydrated material was formed in a mold and a graphite heat generating electric furnace with a nitrogen atmosphere was used to raise the temperature to 1,600° C. in 1 hour and then this temperature was maintained for 2 hours to complete the sintering.

Table 2 and Table 3 show the change in bulk density, flexural strength, toughness, coefficient of friction, and electrical resistance for the carbon nanotube mixture ratio of the obtained composite material. The composite material in Table 2 is formed of SWNT and mullite solid bodies, and the composite material in Table 3 has silica coexisting with MWNT and mullite solid bodies. Table 2 shows for comparison, a composite material synthesized under the same conditions as the mullite solid bodies of the 3Al₂O₃.2SiO₂ structure. Generally, mullite ceramics have less bulk density than alumina ceramics and a characteristic is that the strength is proportional to this. Table 2 shows that high strength and toughness can be obtained by adding SWNT to mullite solid bodies to form nanocomposites. The coefficient of friction and electrical resistance decline rapidly when a small amount of SWNT is added and thus demonstrates a large additive effect.

Table 3 shows the effect from adding MWNT to alumina-silica ceramic in which mullite and silica coexist. Here, there is more silica than mullite composition but the silica does not form crystals and instead is formed as part of the nanocomposites together with the mullite nano crystals. These also coexist with silica that was not formed into nanocomposites, but since the coefficient of thermal expansion is close to that of the carbon nanotubes, there is little residual stress from the difference in thermal expansion from the MWNT, so there is little degradation in strength and toughness and the MWNT pulling out effect provides high toughness and strength. For the electromagnetic absorption of these composite materials a microwave oven was used to study the heat generated through electromagnetic wave absorption and the results are shown in Table 2 and Table 3. The x symbol shows no heat generation, the ∘ symbol shows slight heat generation, and the double ∘ symbol shows marked heat generation. Sintered bodies not containing carbon nanotubes did not generate heat. Composite materials to which 0.5 wt % and 1 Wt % of carbon nanotubes were added that also did not generate heat, but when 2 wt % was added heat was generated, and if more than this was added much more heat was generated.

TABLE 2
Alumina-Silica Ceramic (Mullite) Composite Material Obtained Using Pressureless Sintering

| | | | | Flexural | | | Electrical | Microwave |
|---|---|---|---|---|---|---|---|---|
| SWNT | Al₂O₃ | SiO₂ | Density | Strength | Toughness | Coefficient | Resistance | Oven |
| (wt %) | (wt %) | (wt %) | (g/cm³) | (MPa) | (MPa · m^{1/2}) | of Friction | (Ω · cm) | Heating |
| 1 | 71.1 | 27.9 | 2.68 | 310 | 3.3 | 0.32 | 5.1 × 10⁷ | X |
| 5 | 68.2 | 26.8 | 2.47 | 410 | 5.5 | 0.26 | 4.1 × 10⁵ | ◯◯ |
| 10 | 64.6 | 25.4 | 2.32 | 391 | 5.3 | 0.19 | 5.8 × 10² | ◯◯ |
| 20 | 57.4 | 22.6 | 2.11 | 348 | 4.9 | 0.17 | 2.1 × 10 | ◯◯ |
| 30 | 50.3 | 19.7 | 1.91 | 332 | 4.7 | 0.15 | 9.1 | ◯◯ |
| 40 | 43.1 | 16.9 | 1.72 | 315 | 4.7 | 0.13 | 7.9 | ◯◯ |
| 0 | 71.8 | 28.2 | 2.74 | 245 | 2.9 | 0.81 | 1.5 × 10¹⁴ | X |

TABLE 3
Alumina-Silica Ceramic Composite Material Obtained Using Pressureless Sintering

| | | | | Flexural | | | Electrical | Microwave |
|---|---|---|---|---|---|---|---|---|
| MWNT | Al₂O₃ | SiO₂ | Density | Strength | Toughness | Coefficient | Resistance | Oven |
| (wt %) | (wt %) | (wt %) | (g/cm³) | (MPa) | (MPa · m^{1/2}) | of Friction | (Ω · cm) | Heating |
| 0.5 | 68.5 | 31.0 | 2.61 | 251 | 3.2 | 0.58 | 3.2 × 10⁷ | X |
| 1 | 66.4 | 32.6 | 2.51 | 276 | 3.8 | 0.39 | 4.1 × 10⁶ | X |
| 2 | 61.7 | 36.3 | 2.43 | 283 | 4.1 | 0.27 | 5.5 × 10⁵ | ◯ |
| 5 | 53.2 | 41.8 | 2.21 | 321 | 5.1 | 0.24 | 3.1 × 10³ | ◯◯ |
| 10 | 45.4 | 44.6 | 2.09 | 352 | 4.7 | 0.19 | 8.5 × 10 | ◯◯ |
| 20 | 36.7 | 43.3 | 1.95 | 347 | 4.3 | 0.16 | 9.8 | ◯◯ |
| 30 | 29.5 | 40.5 | 1.73 | 338 | 4.2 | 0.15 | 6.3 | ◯◯ |
| 40 | 23.3 | 36.7 | 1.61 | 311 | 4.1 | 0.13 | 4.9 | ◯◯ |

### Third Embodiment

Multi-wall carbon nanotubes (MWNT), aluminum hydroxide, and silica gel were measured to produce a substantial amount of Al₂O₃ and SiO₂ as shown in Table 4. These materials were mixed with ethanol to form a slurry and to this was added to butylhydroxytoluene to attain approximately 2 vol % of ethanol as a dispersant, and then a rotating and revolving super mixer was used to mix for 1 hour. After drying this mixture material, it was heated to 200° C. in the air using a hot plate and then an atmosphere furnace that was filled with nitrogen gas was used to raise the temperature to 500° C. in 2 hours and then this temperature was maintained for 60 minutes to decompose the aluminum hydroxide and silica gel in the material. This material was packed in a graphite mold and then a hot press was used to pressurize the material to 20 MPa in argon gas while the temperature was raised 800˜1,350° C., and when this temperature was reached it was maintained for 3 hours to synthesize the composite material.

Table 4 shows the change in bulk density, flexural strength, toughness, coefficient of friction, and electrical resistance for the MWNT mixture ratio of the obtained composite material. As shown in Table 4, a dense composite material with high strength and toughness can be manufactured. For comparison, the results for a composite material made from only silica and containing no alumina are shown in FIG. 4. The flexural strength of this composite material is low compared to other materials and it would be difficult to use it as a practical material. The electromagnetic wave absorption of the obtained composite material was studied using a microwave oven and the heating results are shown in Table 4. All composite materials contained a large quantity of carbon nanotubes, so that showed a marked amount of heating.

TABLE 4
Alumina-Silica Ceramic Composite Material Obtained Using Hot Press Sintering

| | | | | Flexural | | | Electrical | Microwave |
|---|---|---|---|---|---|---|---|---|
| MWNT | Al₂O₃ | SiO₂ | Density | Strength | Toughness | Coefficient | Resistance | Oven |
| (wt %) | (wt %) | (wt %) | (g/cm³) | (MPa) | (MPa · m^{1/2}) | of Friction | (Ω · cm) | Heating |
| 50 | 35.9 | 14.1 | 1.73 | 483 | 4.7 | 0.12 | 4.8 | ◯◯ |
| 50 | 30.0 | 20.0 | 1.66 | 451 | 4.6 | 0.14 | 5.3 | ◯◯ |
| 50 | 20.0 | 30.0 | 1.51 | 421 | 4.3 | 0.10 | 5.1 | ◯◯ |
| 50 | 15.0 | 35.0 | 1.48 | 403 | 4.0 | 0.11 | 6.1 | ◯◯ |
| 50 | 10.0 | 40.0 | 1.46 | 385 | 3.8 | 0.12 | 5.5 | ◯◯ |
| 50 | 5.0 | 45.0 | 1.43 | 342 | 3.6 | 0.11 | 5.7 | ◯◯ |
| 50 | 2.5 | 47.5 | 1.41 | 210 | 3.5 | 0.11 | 4.9 | ◯◯ |
| 50 | 0 | 100 | 1.18 | 85 | 3.3 | 0.09 | 5.1 | ◯◯ |

### Fourth Embodiment

Multi-wall carbon nanotubes (MWNT), aluminum hydroxide, and silica gel were measured to produce a substantial amount of Al₂O₃ and SiO₂ as shown in Table 5. These materials were mixed with water to form a slurry and to this was added to propylene glycol to attain approximately 2.5 vol % of water as a dispersant, and then a rotating and revolving super mixer was used to mix for 1.5 hours. After drying this mixture material, it was heated to 210° C. in the air and then an atmosphere furnace that was filled with nitrogen gas was used to raise the temperature to 150° C. over 1 hour, then the temperature was further raised to 650° C. in 1 hour and then this temperature was maintained for 5 minutes to decompose the aluminum hydroxide and silica gel in the material. This hydrated material was packed into a graphite mold, set in spark plasma sintering equipment (SPS), pressurized in a vacuum at 20 MPa, and then the temperature was raised to 1,400° C. in 1 hour and then this temperature was maintained for 10 minutes to obtained the composite material.

Table 5 shows the change in bulk density, flexural strength, toughness, coefficient of friction, and electrical resistance for the MWNT mixture ratio of the obtained composite material. The composite material of Table 5 has a structure in which coexist the MWNT, mullite solid bodies, and silica. As shown in Table 5, even if more than 50 wt % of MWNT is added, a dense composite material can be synthesized using a SPS. The electrical resistance approached that of carbon when 85 wt % of MWNT was added and the coefficient of friction declined markedly. For comparison, Table 5 shows the effect of solid bodies obtained from only MWNT. The solid body mechanical performance is poor compared to composite materials and the large composite effect of alumina-silica ceramics is demonstrated. As shown in Table 5, the electromagnetic absorption was studied using a microwave oven, and the results showed there was marked heating due to the large quantity of carbon nanotubes contained, and only the solid bodies of carbon nanotubes also generated heat.

TABLE 5
Alumina-Silica Ceramic Composite Material Obtained Using Spark Plasma Sintering

| | | | | Flexural | | | Electrical | Microwave |
|---|---|---|---|---|---|---|---|---|
| MWNT | Al₂O₃ | SiO₂ | Density | Strength | Toughness | Coefficient | Resistance | Oven |
| (wt %) | (wt %) | (wt %) | (g/cm³) | (MPa) | (MPa · m^{1/2}) | of Friction | (Ω · cm) | Heating |
| 50 | 34.4 | 15.6 | 1.66 | 351 | 4.1 | 0.17 | 4.1 | ◯◯ |
| 60 | 27.6 | 12.4 | 1.61 | 343 | 4.2 | 0.16 | 3.2 | ◯◯ |
| 65 | 23.5 | 11.5 | 1.55 | 337 | 4.0 | 0.14 | 2.8 | ◯◯ |
| 70 | 16.8 | 13.2 | 1.49 | 329 | 3.9 | 0.13 | 1.6 | ◯◯ |
| 75 | 12.6 | 12.4 | 1.43 | 315 | 3.7 | 0.12 | 1.1 | ◯◯ |
| 80 | 8.4 | 11.6 | 1.37 | 274 | 3.5 | 0.09 | 6.1 × 10⁻¹ | ◯◯ |
| 85 | 5.1 | 9.9 | 1.31 | 151 | 3.2 | 0.08 | 8.9 × 10⁻² | ◯◯ |
| 100 | 0 | 0 | 1.12 | 45 | 2.9 | 0.04 | 6.7 × 10⁻⁴ | ◯◯ |

### INDUSTRIAL APPLICABILITY

As explained in detail above, the carbon nanotube and alumina-silica ceramic containing high-performance composite material of the present invention has improved toughness and strength over conventional alumina-silica ceramics. These composite materials demonstrate high wear resistance and improved coefficient of friction, the electrical resistance declines corresponding to the quantity of carbon nanotubes added, and composite materials with a small quantity of alumina-silica ceramic have an electrical resistance close to that of graphite materials. These composite materials were also shown to have excellent electromagnetic wave absorption characteristics.

The high-performance composite materials of the present invention can be used in fields that use conventional alumina-silica ceramics as well as in new fields utilizing the characteristics of the carbon nanotubes. More specifically, possible applications include, but are not limited to, capacitor type secondary batteries, electron beam printing equipment components, IC manufacturing components, ferrule, cutting edges of knives and other instruments, artificial bones, artificial joints, pulverizing machines components (balls, pulverizing machine parts, internal coverings, etc.), molding machine components (nozzles, cylinders, molds), machine tool components (shafts, bearings, pumps, etc.), tool components (cutting tool bits, snap gauges, bearings, machine platens, ball bearings, welding jigs, etc.), sliding parts (mechanical seals, tilting parts, rolls for wiredrawing machines, pulleys, guide eyes, fishing tackle, ceramic head sliders, slide plates for paper machines, etc.), chemical equipment components (bubbles, stoppers, flow meters, spray nozzles, agitators, shafts, etc.), and other general machine components such as shafts, nozzles, spray nozzles, bearings, and mechanical seals.

Applications in electronic materials of the high-performance composite materials of the present invention include but are not limited to microwave and millimeter wave electromagnetic absorption materials for the wavelength range of 300 MHz˜300 GHz that reflects the functions of chiral forms, which is one of the structures of carbon nanotubes, electromagnetic wave reflecting materials, couplers, modulators, electromagnetic wave switches, antennas, micro mechanical elements, micro sensors, energy conversion elements, radar protection dooms, noise absorption materials, and electromagnetic wave absorption and heat generation materials.

### NUMERICAL REFERENCES

1 Nanocomposite
2 Carbon nanotube
3 Alumina-silica ceramic

What is claimed is:

1. A high-performance composite material, comprised of sintered bodies containing 0.1˜90 mass % carbon nanotubes and 99.9˜10 mass % alumina-silica ceramic, wherein the alumina-silica ceramic contains 99.5˜5 mass % alumina and 0.5˜95 mass % silica; and having included nanocomposite structural elements of the carbon nanotubes and the alumina-silica ceramic nano crystals being mutually intertwined.

2. A high-performance composite material according to claim 1, wherein the composite material has a coefficient of friction of 0.07˜0.30 and electrical resistance of 10⁻²˜10⁷ Ω/cm.

3. A method of manufacturing the high-performance composite material comprising the steps of:
placing the carbon nanotubes and the alumina-silica ceramic raw material containing 99.5˜5 mass % of aluminum hydroxide (Al(OH)₃) in a suitable quantity of alumina and 0.5˜95 mass % silica gel (SiO₂.nH₂O) in a suitable quantity of silica in a water or alcohol solvent at a ratio of 0.1˜90 mass % of the carbon nanotubes and 99.9˜10 mass % of the alumina-silica ceramic material,
creating a slurry that is mixed for 3˜180 minutes, and then
removing the solvent from the raw material mixture, and
sintering for 5 minutes to 5 hours in a temperature range of 800° C.˜1,800° C. in a non-oxygenated atmosphere.

4. A method for manufacturing the high-performance composite material according to claim 3, wherein for preprocessing to perform the sintering the solvent is removed from the mixture material and then the mixture material is heated to within the range of 200° C.˜900° C. in a non-oxygenated atmosphere for 5˜60 minutes as pre-sintering for decomposition and dehydration.
